(19) United States
(12) Patent Application Publication
(10) Pub. No.: US 2018/0180718 A1
(43) Pub. Date: Jun. 28, 2018

(54) DISTANCE DETECTING DEVICE USING LASER BEAM

(71) Applicant: HON HAI PRECISION INDUSTRY CO., LTD., New Taipei (TW)

(72) Inventor: PO-YU LIN, New Taipei (TW)

(21) Appl. No.: 15/485,405

(22) Filed: Apr. 12, 2017

(30) Foreign Application Priority Data
Dec. 28, 2016 (TW) 105143569

(51) Int. Cl. G01S 7/481; G02B 3/04

(52) U.S. Cl. CPC G01S 7/4811; G01S 7/4813; G01S 7/4815; G02B 3/04

(57) ABSTRACT

A high-precision distance detecting device using laser beam includes a laser transmitter, a laser receiver, and at least one lens assembly. Each lens assembly includes a collimating lens portion facing the laser transmitter and a focusing lens portion facing the laser receiver. The focusing lens portion is connected to the collimating lens portion.

### FIELD

The subject matter herein generally relates to distance detecting devices, and more particularly, to a distance detecting device using laser beam.

### BACKGROUND

Distance detecting devices usually employs laser beam to detect distances between the distance detecting devices and objects based on a Time of Flight (TOF) rule. Such a distance detecting device usually comprises a laser emitter, a collimating lens portion, a focusing lens portion, a laser receiver, and a signal processor. The laser emitter emits laser beam. The collimating lens portion collimates the laser beam towards the object, which then reflects the laser beam to the focusing lens portion. The focusing lens portion focuses the laser beam to the laser receiver. By recording an occurrence time of transmitting the laser beam (hereinafter, “transmitting time”) and an occurrence time of receiving the laser beam (hereinafter, “receiving time”), a time duration can be calculated according to a difference between the transmitting time and the receiving time. Then, the distance between the distance detecting device and the object can be calculated according to the time duration and the speed of the laser beam.

However, the collimating lens portion and the focusing lens portion are typically separated, which may increase the error in position and angle of the collimating lens portion and the focusing lens portion when assembled and further increase the size of the distance detecting device.

### BRIEF DESCRIPTION OF THE DRAWINGS

Implementations of the present technology will now be described, by way of example only, with reference to the attached figures.

FIG. 1 is a diagrammatic view of an exemplary embodiment of a distance detecting device.

FIG. 2 is a diagrammatic view of another exemplary embodiment of a distance detecting device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

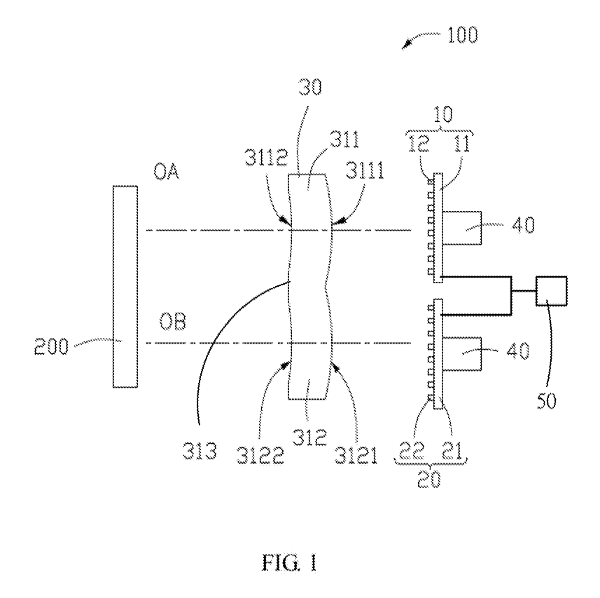

FIG. 1 illustrates an exemplary embodiment of a distance detecting device 100 which can detect a distance between the distance detecting device 100 and an object 200 using a laser beam. The distance detecting device 100 comprises a laser transmitter 10, a laser receiver 20, and a lens assembly 30.

The laser transmitter 10 comprises a first substrate 11 and at least one laser diode 12 mounted on the first substrate 11. Each laser diode 12 can emit a laser beam.

The laser receiver 20 comprises a second substrate 21 and at least one photodiode 22 mounted on the second substrate 21. Each photodiode 22 can receive the reflected laser beam. In at least one exemplary embodiment, the first substrate 11 and the second substrate 21 are separated. In another exemplary embodiment, the first substrate 11 and the second substrate 21 are combined to form a single substrate. The first substrate 11 and the second substrate 21 can be printed circuit boards (PCBs).

The lens assembly 30 comprises a collimating lens portion 311 and a focusing lens portion 312 connected to the collimating lens portion 311. The collimating lens portion 311 faces the laser transmitter 10, and can collimate the laser beam from the laser transmitter 10 towards the object 200. The focusing lens portion 312 faces the laser receiver 20, and can receive the laser beam reflected by the object 200.

The lens assembly 30 further comprises a connecting portion 313 positioned between and connected to the collimating lens portion 311 and the focusing lens portion 312. The collimating lens portion 311, the focusing lens portion 312, and the connecting portion 313 are integrally formed. Thus, an error in position and angle of the collimating lens portion 311 and the focusing lens portion 312 when assembled is decreased, and the size of the distance detecting device 100 is also decreased. In the exemplary embodiment, the lens assembly 30 is made of glass or resin. The connecting portion 313 is flat.

The collimating lens portion 311 comprises a first laser incident surface 3111 facing the laser transmitter 10 and a first laser emitting surface 3112 opposite to the first laser incident surface 3111. The focusing lens portion 312 comprises a second laser emitting surface 3121 facing the laser receiver 20 and a second laser incident surface 3122 opposite to the second laser emitting surface 3121. The first laser incident surface 3111 is connected to the second laser emitting surface 3121. The first laser emitting surface 3112 is connected to the second laser incident surface 3122. The first laser incident surface 3111, the first laser emitting surface 3112, the second laser incident surface 3122, and the second laser emitting surface 3121 are aspherical. That is, the first laser incident surface 3111, the first laser emitting surface 3112, the second laser incident surface 3122, and the second laser emitting surface 3121 can be concave, convex, or flat. In at least one exemplary embodiment, both of the first laser incident surface 3111 and the second laser emitting surface 3121 are either concave or convex. Both of the first laser emitting surface 3112 and the second laser incident surface 3122 are either concave or convex.

When in use, the laser diode 12 of the laser transmitter 10 emits laser beam to the first laser incident surface 3111 of the collimating lens portion 311. The collimating lens portion 311 collimates the laser beam, and the collimated laser beam exits the first laser emitting surface 3112 and travels to the object 200. The object 200 reflects the laser beam to the second laser incident surface 3122 of the focusing lens portion 312. The focusing lens portion 312 focuses the laser beam, and the focused laser beam exits the second laser emitting surface 3121 and travels to the laser receiver 20. The photodiode 22 of the laser receiver 20 receives the laser beam.

The distance detecting device 100 further comprises a processor 50 electrically connected to the laser transmitter 10 and the laser receiver 20. The processor 50 can record an occurrence time of the laser transmitter 10 transmitting the laser beam (hereinafter, “transmitting time”) and an occurrence time of the laser receiver 20 receiving the laser beam (hereinafter, “receiving time”). The processor 50 further calculates a time duration according to a difference between the transmitting time and the receiving time, and calculates the distance between the distance detecting device 100 and the object 200 according to the time duration and the speed of the laser beam.

The distance detecting device 100 further comprises two motors 40. The two motors 40 are connected to the first substrate 11 and the second substrate 21, respectively, and can drive the first substrate 11 and the second substrate 21 to rotate in plane of the first substrate 11 and the second substrate 21. The two motors 40 can also drive the first substrate 11 and the second substrate 21 to incline and change an angle defined by an optical axis “OA” of the collimating lens portion 311 and the first substrate 11 and an angle defined by an optical axis “OB” of the focusing lens portion 312 and the second substrate 21. As such, more laser beam can be received by the collimating lens portion 311 and the photodiode 22. In another exemplary embodiment, the first substrate 11 and the second substrate 21 are connected to one single motor 40.

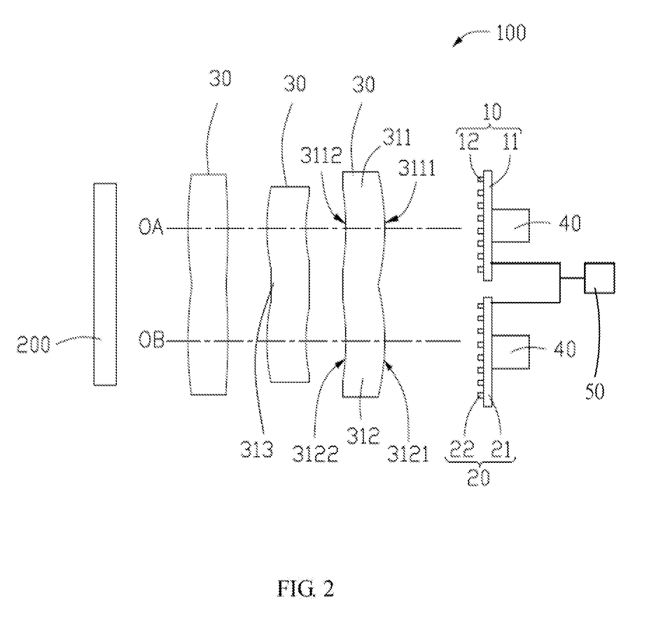

In another exemplary embodiment, the distance detecting device 100 comprises a number of lens assemblies 30 arranged in an array along a direction away from the laser transmitter 10 and the laser receiver 20. FIG. 2 illustrates that the distance detecting device 100 comprises three lens assemblies 30, that is, an innermost lens assembly 30, an outermost lens assembly 30, and a middle lens assembly 30. Both the first laser incident surface 3111 and the second laser emitting surface 3121 of the innermost lens assembly 30 are either convex, and both the first laser emitting surface 3112 and the second laser incident surface 3122 of the innermost lens assembly 30 are either concave. Both the first laser incident surface 3111 and the second laser emitting surface 3121 of the middle lens assembly 30 are either concave, and both the first laser emitting surface 3112 and the second laser incident surface 3122 of the middle lens assembly 30 are either convex. The first laser incident surface 3111, the second laser emitting surface 3121, the first laser emitting surface 3112, and the second laser incident surface 3122 of the outermost lens assembly 30 are all convex.

Even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments, to the full extent indicated by the plain meaning of the terms in which the appended claims are expressed.

What is claimed is:

1. A distance detecting device using laser beam comprising:
a laser transmitter;
a laser receiver; and
at least one lens assembly, each lens assembly comprising:
a collimating lens portion facing the laser transmitter; and
a focusing lens portion facing the laser receiver and connected to the collimating lens portion.

2. The distance detecting device of claim 1, wherein each lens assembly further comprises a connecting portion positioned between and connected to the collimating lens portion and the focusing lens portion, the collimating lens portion, the focusing lens portion, and the connecting portion are integrally formed.

3. The distance detecting device of claim 1, wherein the collimating lens portion comprises a first laser incident surface facing the laser transmitter and a first laser emitting surface opposite to the first laser incident surface, the focusing lens portion comprises a second laser emitting surface facing the laser receiver and a second laser incident surface opposite to the second laser emitting surface, the first laser incident surface is connected to the second laser emitting surface, the first laser emitting surface is connected to the second laser incident surface.

4. The distance detecting device of claim 3, wherein the first laser incident surface, the first laser emitting surface, the second laser incident surface, and the second laser emitting surface are aspherical.

5. The distance detecting device of claim 4, wherein both of the first laser incident surface and the second laser emitting surface are either concave or convex, both of the first laser emitting surface and the second laser incident surface are either concave or convex.

6. The distance detecting device of claim 1, wherein the laser transmitter comprises a first substrate and at least one laser diode mounted on the first substrate, each laser diode is configured to emit laser beam.

7. The distance detecting device of claim 6, wherein the laser receiver comprises a second substrate and at least one photodiode mounted on the second substrate, each photodiode is configured to receive laser beam.

8. The distance detecting device of claim 7, the first substrate and the second substrate are printed circuit boards.

9. The distance detecting device of claim 7, further comprising at least one motor, wherein the at least one motor is connected to the first substrate and the second substrate, and is configured to drive the first substrate and the second substrate to rotate in plane of the first substrate and the second substrate.

10. The distance detecting device of claim 7, further comprising at least one motor, wherein the at least one motor is connected to the first substrate and the second substrate, and is configured to drive the first substrate and the second substrate to incline and change an angle defined by an optical axis of the collimating lens portion and the first substrate and an angle defined by an optical axis of the focusing lens portion and the second substrate.

11. The distance detecting device of claim 1, further comprising a processor, wherein the processor is electrically connected to the laser transmitter and the laser receiver, and is configured to record a transmitting time of the laser transmitter transmitting the laser beam and a receiving time of the laser receiver receiving the laser beam, calculate a time duration according to a difference between the transmitting time and the receiving time, and calculate a distance between the distance detecting device and an object according to the time duration and a speed of the laser beam.

12. The distance detecting device of claim 1, wherein the distance detecting device comprises a plurality of lens assemblies arranged in an array along a direction away from the laser transmitter and the laser receiver.
